(19) United States
(12) Patent Application Publication
(10) Pub. No.: US 2024/0259931 A1
(43) Pub. Date: Aug. 1, 2024

(54) TRANSPORT NETWORK DOMAIN SLICING ARCHITECTURE

(71) Applicants: Rakuten Symphony India Private Limited, Indore (IN); Rakuten Symphony UK LTD, Weybridge, Surrey (GB)

(72) Inventors: Amit Dhamija, Indore (IN); Kexuan Sun, Surrey (GB)

(21) Appl. No.: 18/248,765

(22) PCT Filed: Mar. 16, 2023
(86) PCT No.: PCT/US23/64554

§ 371 Date: Apr. 12, 2023

(30) Foreign Application Priority Data
Nov. 11, 2022 (IN) 202221064468

(51) Int. Cl. H04W 48/18; H04W 24/02; H04W 28/24

(52) U.S. Cl. CPC H04W 48/18; H04W 24/02; H04W 28/24

(57) ABSTRACT

Embodiments are directed to systems, apparatuses, and methods including a network slice management function (NSMF) and a transport network-network slice subnet management function (TN-NSSMF). The NSMF is configured to request at least a transport network (TN) domain in a network architecture to create a TN portion of a network slice in a wireless communications system. The TN-NSSMF) is configured to manage the TN portion of the network slice. One of the NSMF and the TN-NSSMF has artificial intelligence/machine learning (AI/ML) integrated therein that is configured to allow the one of the NSMF and the TN-NSSMF to monitor and analyze performance of the network slice in the TN domain.

### CROSS REFERENCE TO RELATED APPLICATIONS

The present application claims priority to Indian Patent Application No. 202221064468 entitled “Transport Network Domain Slicing Performance Monitoring, Analytics And SLA Assurance” filed Nov. 11, 2022, which is hereby incorporated by reference in its entirety.

### TECHNICAL FIELD

In some implementations, the current subject matter relates to telecommunications systems, and in particular, to transport network domain slicing architecture.

### BACKGROUND

In today's world, cellular networks provide on-demand communications capabilities to individuals and business entities. Typically, a cellular network is a wireless network that can be distributed over land areas, which are called cells. Each such cell is served by at least one fixed-location transceiver, which is referred to as a cell site or a base station. Each cell can use a different set of frequencies than its neighbor cells in order to avoid interference and provide improved service within each cell. When cells are joined together, they provide radio coverage over a wide geographic area, which enables a large number of mobile telephones, and/or other wireless devices or portable transceivers to communicate with each other and with fixed transceivers and telephones anywhere in the network. Such communications are performed through base stations and are accomplished even if the mobile transceivers are moving through more than one cell during transmission. Major wireless communications providers have deployed such cell sites throughout the world, thereby allowing communications mobile phones and mobile computing devices to be connected to the public switched telephone network and public Internet.

A mobile telephone is a portable telephone that is capable of receiving and/or making telephone and/or data calls through a cell site or a transmitting tower by using radio waves to transfer signals to and from the mobile telephone. In view of a large number of mobile telephone users, current mobile telephone networks provide a limited and shared resource. In that regard, cell sites and handsets can change frequency and use low power transmitters to allow simultaneous usage of the networks by many callers with less interference. Coverage by a cell site can depend on a particular geographical location and/or a number of users that can potentially use the network. For example, in a city, a cell site can have a range of up to approximately ½ mile; in rural areas, the range can be as much as 5 miles; and in some areas, a user can receive signals from a cell site 25 miles away.

The following are examples of some of the digital cellular technologies that are in use by the communications providers: Global System for Mobile Communications (“GSM”), General Packet Radio Service (“GPRS”), cdmaOne, CDMA2000, Evolution-Data Optimized (“EV-DO”), Enhanced Data Rates for GSM Evolution (“EDGE”), Universal Mobile Telecommunications System (“UMTS”), Digital Enhanced Cordless Telecommunications (“DECT”), Digital AMPS (“IS-136/TDMA”), and Integrated Digital Enhanced Network (“iDEN”). The Long Term Evolution, or 4G LTE, which was developed by the Third Generation Partnership Project (“3GPP”) standards body, is a standard for a wireless communication of high-speed data for mobile phones and data terminals. A 5G standard is currently being developed and deployed. 3GPP cellular technologies like LTE and 5G NR are evolutions of earlier generation 3GPP technologies like the GSM/EDGE and UMTS/HSPA digital cellular technologies and allows for increasing capacity and speed by using a different radio interface together with core network improvements.

Cellular networks can be divided into radio access networks and core networks. The radio access network (“RAN”) can include network functions that can handle radio layer communications processing. The core network can include network functions that can handle higher layer communications, e.g., internet protocol (“IP”), transport layer and applications layer. In some cases, the RAN functions can be split into baseband unit functions and the radio unit functions, where a radio unit connected to a baseband unit via a fronthaul network, for example, can be responsible for lower layer processing of a radio physical layer while a baseband unit can be responsible for the higher layer radio protocols, e.g., MAC, RLC, etc.

One network technology that may be used in a cellular network is network slicing for RANs and core networks (“CNs”) that are interconnected to each other via transport networks (“TNs”). Under network slicing, network resources and network functions may be bundled into network slices depending on individual services, service level agreements (SLAs), and/or network path routing to be provided by each network slice. That is, a network slice over a cellular network may provide customized network services by combining control plane (“CP”) and user plane (“UP”) network functions for network services necessary for a particular service over a CN and a RAN.

Aspects of slice creation and reserving resources in RAN and CN domains are defined by standards, e.g., by standards of 3GPP and Internet Engineering Task Force (“IETF”). However, aspects of slice creation and reserving resources in a TN domain are not defined by standards, e.g., by standards of 3GPP and IETF.

Thus, there exists a need for further improvements in network slicing technology.

### SUMMARY

In some implementations, the current subject matter relates to an apparatus. The apparatus can include a network slice management function (NSMF) and a transport network-network slice subnet management function (TN-NSSMF). The NSMF is configured to request at least a transport network (TN) domain in a network architecture to create a TN portion of a network slice in a wireless communications system. The TN-NSSMF is configured to manage the TN portion of the network slice. One of the NSMF and the TN-NSSMF has artificial intelligence/machine learning (AI/ML) integrated therein that is configured to allow the one of the NSMF and the TN-NSSMF to monitor and analyze performance of the network slice in the TN domain.

The apparatus may allow monitoring and analyzing TN domain slicing performance and generating necessary actions to optimize and assure end-to-end (E2E) network slicing service level agreement (SLA) from the TN domain aspect.

In some implementations, the current subject matter can include one or more of the following optional features.

In some implementations, the apparatus can further include a representational state transfer application programming interface (REST-API) interface between the NSMF and the TN-NSSMF.

In some implementations, the one of the NSMF and the TN-NSSMF that has the AI/ML integrated therein can be the NSMF. Further, the NSMF can be configured to collect input data for a workflow of the AI/ML, such as model training and/or inference, and the input data can include one or more of the following: data mapping between aggregation of radio access network (RAN) and core slices with S-NSSAI and transport slice identifiers (Tx-Slice-ID), data mapping between Tx-Slice-ID and logical Dedicated Forwarding Planes (DFPs) paths, telemetry data telemetry data that provides health of a forwarding plane per each DFP, traffic matrices that provide bandwidth consumption of all the slicing flows for each transport link, and segment routing over IPv6 (SRv6) performance management (SRv6-PM) reports. Further, the apparatus can also include a REST-API interface between the NSMF and the TN-NSSMF, and the NSMF can be configured to collect at least some of the input data for the AI/ML via the REST-API interface.

In some implementations, the one of the NSMF and the TN-NSSMF that has the AI/ML integrated therein can be the TN-NSSMF. Further, the TN-NSSMF can includes a network slice controller (NSC) or a TN domain manager; the TN-NSSMF can be configured to collect input data for the workflow of the AI/ML, such as model training and/or inference, and the input data can include one or more of the following: data mapping between aggregation of radio access network (RAN) and core slices with S-NSSAI and transport slice identifiers (Tx-Slice-ID), data mapping between Tx-Slice-ID and logical Dedicated Forwarding Planes (DFPs) paths, telemetry data telemetry data that provides health of a forwarding plane per each DFP, traffic matrices that provide bandwidth consumption of all the slicing flows for each transport link, and segment routing over IPv6 (SRv6) performance management (SRv6-PM) reports; and/or the apparatus can also include a REST-API interface between the NSMF and the TN-NSSMF, the TN-NSSMF can be configured to collect slice-mapping and application service level agreement (SLA) information from the NSMF via the REST-API interface.

In some implementations, the NSMF can be configured to be communicatively coupled to the TN domain, a RAN domain, and a core network (CN) domain. Further, the RAN domain can include at least one base station therein, and the base station can include at least one of an eNodeB and a gNodeB.

In some implementations, the wireless communications system can include at least one of a 5G New Radio (NR) communications system and a long term evolution (LTE) communication system.

In some implementations, the AI/ML can include a linear regression model, a Feed Forward Network (FFN)/Convolutional Neural Network (CNN) model, or a Long Short-Term Memory (LSTM) model), or the AI/ML can include a model repository including one or more of the linear regression model, the FFN/CNN model, and the LSTM model, with the AI/ML configured to select a model from the model repository at random or based on initial configuration requirements input by a user. In related implementations, the AI/ML is configured to use the selected model to perform an evaluation of structured data packets and/or configuration parameters of the wireless communications system to generate a performance score of the network slice, with the configuration parameters including one or more of: TN topology information, TN configuration information, high-level policy information, and subnet information. In some implementations, the AI/ML is configured to take a corrective action based on the performance score of the network slice, and the corrective action can include creation of a new forwarding plane or assigning additional networks to the network slice.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### BRIEF DESCRIPTION OF THE DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1a illustrates an exemplary conventional long term evolution (“LTE”) communications system;

FIG. 1b illustrates further detail of the exemplary LTE system shown in FIG. 1a;

FIG. 1c illustrates additional detail of the evolved packet core of the exemplary LTE system shown in FIG. 1a;

FIG. 1d illustrates an exemplary evolved Node B of the exemplary LTE system shown in FIG. Ta;

FIG. 2 illustrates further detail of an evolved Node B shown in FIGS. 1a-d;

FIG. 3 illustrates an exemplary virtual radio access network, according to some implementations of the current subject matter;

FIG. 4 illustrates an exemplary 3GPP split architecture to provide its users with use of higher frequency bands;

FIG. 5a illustrates an exemplary 5G wireless communication system;

FIG. 5b illustrates an exemplary layer architecture of the split gNB and/or a split ng-eNB (e.g., next generation eNB that may be connected to 5GC);

FIG. 5c illustrates an exemplary functional split in the gNB architecture shown in FIGS. 5a-b;

FIG. 6 illustrates an exemplary wireless communications system, according to some implementations of the current subject matter;

FIG. 7 illustrates an exemplary a high-level network slice architecture, according to some implementations of the current subject matter;

FIG. 8a is a schematic diagram illustrating an exemplary incorporation of AI/ML in NSMF, according to some implementations of the current subject matter;

FIG. 8b is a schematic diagram illustrating an exemplary incorporation of AI/ML in an NSC/TN domain manager, according to some implementations of the current subject matter;

FIG. 9 illustrates an exemplary traffic matrix label, according to some implementations of the current subject matter;

FIG. 10 illustrates an exemplary UE for a transport network domain slicing performance monitoring, analytics and SLA assurance based on AI/ML, according to some implementations of the current subject matter; and

FIG. 11 illustrates an exemplary system, according to some implementations of the current subject matter.

FIG. 12 illustrates an exemplary system, according to some implementations of the current subject matter.

### DETAILED DESCRIPTION

The current subject matter can provide for systems and methods that can be implemented in wireless communications systems. Such systems can include various wireless communications systems, including 5G New Radio communications systems, long term evolution communication systems, etc.

In general, the current subject matter relates to transport network domain slicing architecture.

In some implementations of the current subject matter, a transport network domain slicing performance monitoring, analytics and service level agreement (SLA) assurance based on artificial intelligence/machine learning (AI/ML) is provided. A network slice architecture includes network slice management function (NSMF) or network slice controller/transport network (NSC/TN) domain manager integration with the AI/ML. The NSMF or NSC/TN domain manager is associated with other northbound interfaces and with representational state transfer application programming interface (REST-API) interfaces between the NSC and the NSMF. The AI/ML integration is used for monitoring and analyzing TN domain slicing performance and generating necessary actions to optimize and assure end-to-end (E2E) network slicing SLA from the TN domain aspect.

3GPP standards defining one or more aspects that may be related to the current subject matter include 3GPP TS 28.531 “3rd Generation Partnership Project; Technical Specification Group Services and System Aspects; Management and orchestration; Provisioning” and 3GPP TS 28.533 “3rd Generation Partnership Project; Technical Specification Group Services and System Aspects; Management and orchestration; Architecture framework.” Standards of IETF and/or the O-RAN Alliance may also be related to one or more aspects of the current subject matter.

One or more aspects of the current subject matter can be incorporated into transmitter and/or receiver components of base stations (e.g., gNodeBs, eNodeBs, etc.) in such communications systems. The following is a general discussion of long-term evolution communications systems and 5G New Radio communication systems.

### I. Long Term Evolution Communications System

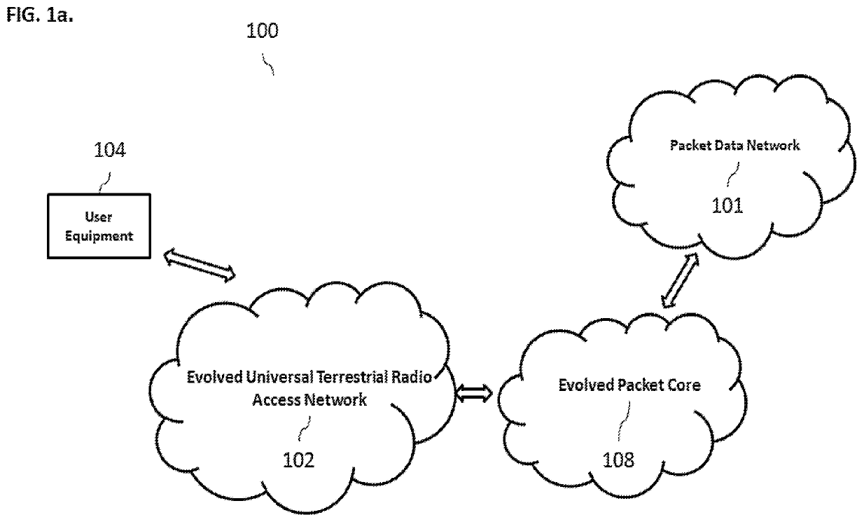

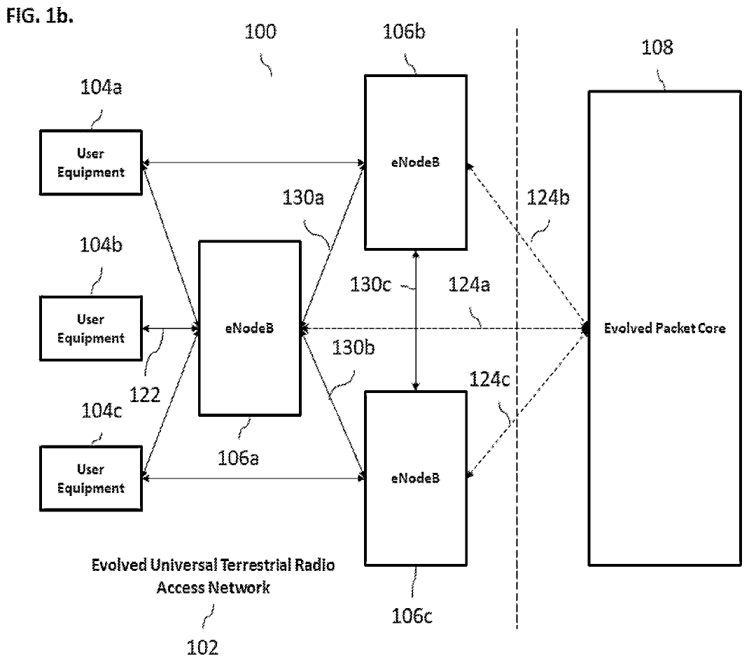

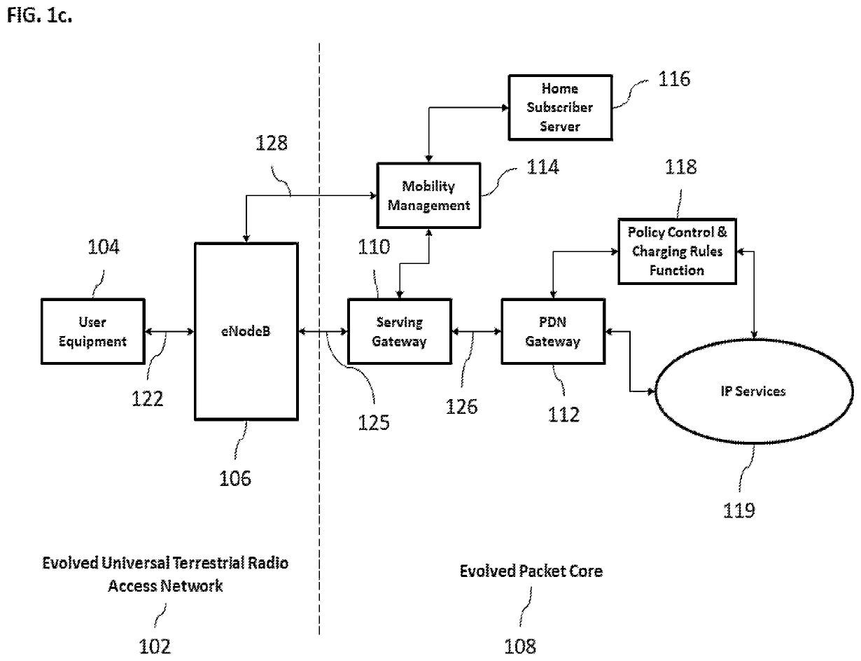

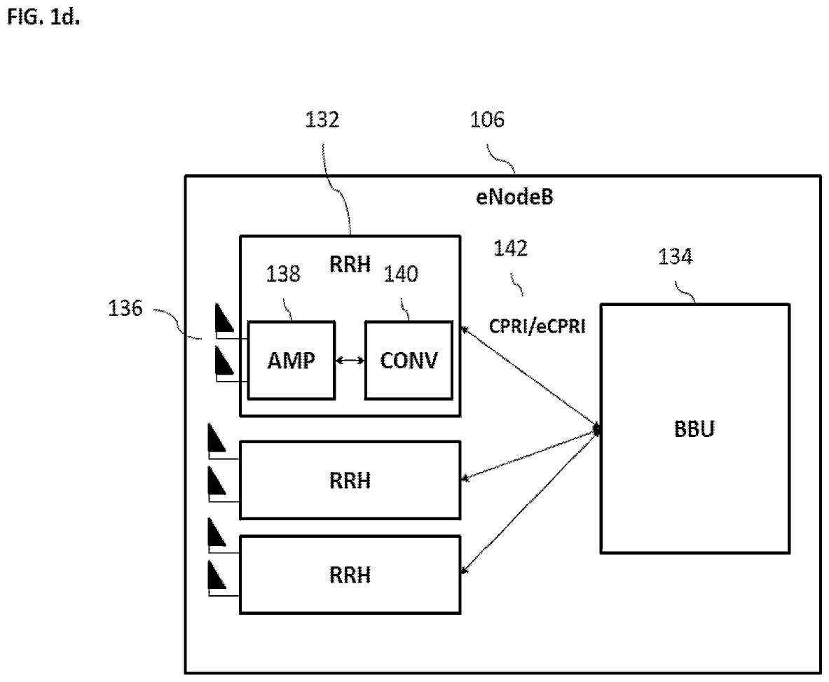

FIGS. 1a-c and 2 illustrate an exemplary conventional long-term evolution (“LTE”) communication system 100 along with its various components. An LTE system or a 4G LTE, as it is commercially known, is governed by a standard for wireless communication of high-speed data for mobile telephones and data terminals. The standard is an evolution of the GSM/EDGE (“Global System for Mobile Communications”/“Enhanced Data rates for GSM Evolution”) as well as UMTS/HSPA (“Universal Mobile Telecommunications System”/“High Speed Packet Access”) network technologies. The standard was developed by the 3GPP (“3rd Generation Partnership Project”).

As shown in FIG. 1a, the system 100 can include an evolved universal terrestrial radio access network (“EUTRAN”) 102, an evolved packet core (“EPC”) 108, and a packet data network (“PDN”) 101, where the EUTRAN 102 and EPC 108 provide communication between a user equipment 104 and the PDN 101. The EUTRAN 102 can include a plurality of evolved node B's (“eNodeB” or “ENODEB” or “enodeb” or “eNB”) or base stations 106 (a, b, c) (as shown in FIG. 1b) that provide communication capabilities to a plurality of user equipment 104(a, b, c). The user equipment 104 can be a mobile telephone, a smartphone, a tablet, a personal computer, a personal digital assistant (“PDA”), a server, a data terminal, and/or any other type of user equipment, and/or any combination thereof. The user equipment 104 can connect to the EPC 108 and eventually, the PDN 101, via any eNodeB 106. Typically, the user equipment 104 can connect to the nearest, in terms of distance, eNodeB 106. In the LTE system 100, the EUTRAN 102 and EPC 108 work together to provide connectivity, mobility and services for the user equipment 104.

FIG. 1b illustrates further detail of the network 100 shown in FIG. 1a. As stated above, the EUTRAN 102 includes a plurality of eNodeBs 106, also known as cell sites. The eNodeBs 106 provides radio functions and performs key control functions including scheduling of air link resources or radio resource management, active mode mobility or handover, and admission control for services. The eNodeBs 106 are responsible for selecting which mobility management entities (MMEs, as shown in FIG. 1c) will serve the user equipment 104 and for protocol features like header compression and encryption. The eNodeBs 106 that make up an EUTRAN 102 collaborate with one another for radio resource management and handover.

Communication between the user equipment 104 and the eNodeB 106 occurs via an air interface 122 (also known as “LTE-Uu” interface). As shown in FIG. 1b, the air interface 122 provides communication between user equipment 104b and the eNodeB 106a. The air interface 122 uses Orthogonal Frequency Division Multiple Access (“OFDMA”) and Single Carrier Frequency Division Multiple Access (“SC-FDMA”), an OFDMA variant, on the downlink and uplink respectively. OFDMA allows use of multiple known antenna techniques, such as, Multiple Input Multiple Output (“MIMO”).

The air interface 122 uses various protocols, which include a radio resource control (“RRC”) for signaling between the user equipment 104 and eNodeB 106 and non-access stratum (“NAS”) for signaling between the user equipment 104 and MME (as shown in FIG. 1c). In addition to signaling, user traffic is transferred between the user equipment 104 and eNodeB 106. Both signaling and traffic in the system 100 are carried by physical layer (“PHY”) channels.

Multiple eNodeBs 106 can be interconnected with one another using an X2 interface 130(a, b, c). As shown in FIG. 1b, X2 interface 130a provides interconnection between eNodeB 106a and eNodeB 106b; X2 interface 130b provides interconnection between eNodeB 106a and eNodeB 106c; and X2 interface 130c provides interconnection between eNodeB 106b and eNodeB 106c. The X2 interface can be established between two eNodeBs in order to provide an exchange of signals, which can include a load- or interference-related information as well as handover-related information. The eNodeBs 106 communicate with the evolved packet core 108 via an S1 interface 124(a, b, c). The S1 interface 124 can be split into two interfaces: one for the control plane (shown as control plane interface (S1-MME interface) 128 in FIG. 1c) and the other for the user plane (shown as user plane interface (S1-U interface) 125 in FIG. 1c).

The EPC 108 establishes and enforces Quality of Service (“QoS”) for user services and allows user equipment 104 to maintain a consistent internet protocol (“IP”) address while moving. It should be noted that each node in the network 100 has its own IP address. The EPC 108 is designed to interwork with legacy wireless networks. The EPC 108 is also designed to separate control plane (i.e., signaling) and user plane (i.e., traffic) in the core network architecture, which allows more flexibility in implementation, and independent scalability of the control and user data functions.

The EPC 108 architecture is dedicated to packet data and is shown in more detail in FIG. 1c. The EPC 108 includes a serving gateway (S-GW) 110, a PDN gateway (P-GW) 112, a mobility management entity (“MME”) 114, a home subscriber server (“HSS”) 116 (a subscriber database for the EPC 108), and a policy control and charging rules function (“PCRF”) 118. Some of these (such as S-GW, P-GW, MME, and HSS) are often combined into nodes according to the manufacturer's implementation.

The S-GW 110 functions as an IP packet data router and is the user equipment's bearer path anchor in the EPC 108. Thus, as the user equipment moves from one eNodeB 106 to another during mobility operations, the S-GW 110 remains the same and the bearer path towards the EUTRAN 102 is switched to talk to the new eNodeB 106 serving the user equipment 104. If the user equipment 104 moves to the domain of another S-GW 110, the MME 114 will transfer all of the user equipment's bearer paths to the new S-GW. The S-GW 110 establishes bearer paths for the user equipment to one or more P-GWs 112. If downstream data are received for an idle user equipment, the S-GW 110 buffers the downstream packets and requests the MME 114 to locate and reestablish the bearer paths to and through the EUTRAN 102.

The P-GW 112 is the gateway between the EPC 108 (and the user equipment 104 and the EUTRAN 102) and PDN 101 (shown in FIG. 1a). The P-GW 112 functions as a router for user traffic as well as performs functions on behalf of the user equipment. These include IP address allocation for the user equipment, packet filtering of downstream user traffic to ensure it is placed on the appropriate bearer path, enforcement of downstream QoS, including data rate. Depending upon the services a subscriber is using, there may be multiple user data bearer paths between the user equipment 104 and P-GW 112. The subscriber can use services on PDNs served by different P-GWs, in which case the user equipment has at least one bearer path established to each P-GW 112. During handover of the user equipment from one eNodeB to another, if the S-GW 110 is also changing, the bearer path from the P-GW 112 is switched to the new S-GW.

The MME 114 manages user equipment 104 within the EPC 108, including managing subscriber authentication, maintaining a context for authenticated user equipment 104, establishing data bearer paths in the network for user traffic, and keeping track of the location of idle mobiles that have not detached from the network. For idle user equipment 104 that needs to be reconnected to the access network to receive downstream data, the MME 114 initiates paging to locate the user equipment and re-establishes the bearer paths to and through the EUTRAN 102. MME 114 for a particular user equipment 104 is selected by the eNodeB 106 from which the user equipment 104 initiates system access. The MME is typically part of a collection of MMEs in the EPC 108 for the purposes of load sharing and redundancy. In the establishment of the user's data bearer paths, the MME 114 is responsible for selecting the P-GW 112 and the S-GW 110, which will make up the ends of the data path through the EPC 108.

The PCRF 118 is responsible for policy control decision-making, as well as for controlling the flow-based charging functionalities in the policy control enforcement function (“PCEF”), which resides in the P-GW 110. The PCRF 118 provides the QoS authorization (QoS class identifier (“QCI”) and bit rates) that decides how a certain data flow will be treated in the PCEF and ensures that this is in accordance with the user's subscription profile.

As stated above, the IP services 119 are provided by the PDN 101 (as shown in FIG. 1a).

FIG. 1d illustrates an exemplary structure of eNodeB 106. The eNodeB 106 can include at least one remote radio head (“RRH”) 132 (typically, there can be three RRH 132) and a baseband unit (“BBU”) 134. The RRH 132 can be connected to antennas 136. The RRH 132 and the BBU 134 can be connected using an optical interface that is compliant with common public radio interface (“CPRI”)/enhanced CPRI (“eCPRI”) 142 standard specification either using RRH specific custom control and user plane framing methods or using O-RAN Alliance compliant Control and User plane framing methods. The operation of the eNodeB 106 can be characterized using the following standard parameters (and specifications): radio frequency band (Band4, Band9, Band17, etc.), bandwidth (5, 10, 15, 20 MHz), access scheme (downlink: OFDMA; uplink: SC-OFDMA), antenna technology (Single user and multi user MIMO; Uplink: Single user and multi user MIMO), number of sectors (6 maximum), maximum transmission rate (downlink: 150 Mb/s; uplink: 50 Mb/s), S1/X2 interface (1000Base-SX, 1000Base-T), and mobile environment (up to 350 km/h). The BBU 134 can be responsible for digital baseband signal processing, termination of S1 line, termination of X2 line, call processing and monitoring control processing. IP packets that are received from the EPC 108 (not shown in FIG. 1d) can be modulated into digital baseband signals and transmitted to the RRH 132. Conversely, the digital baseband signals received from the RRH 132 can be demodulated into IP packets for transmission to EPC 108.

The RRH 132 can transmit and receive wireless signals using antennas 136. The RRH 132 can convert (using converter (“CONV”) 140) digital baseband signals from the BBU 134 into radio frequency (“RF”) signals and power amplify (using amplifier (“AMP”) 138) them for transmission to user equipment 104 (not shown in FIG. 1d). Conversely, the RF signals that are received from user equipment 104 are amplified (using AMP 138) and converted (using CONV 140) to digital baseband signals for transmission to the BBU 134.

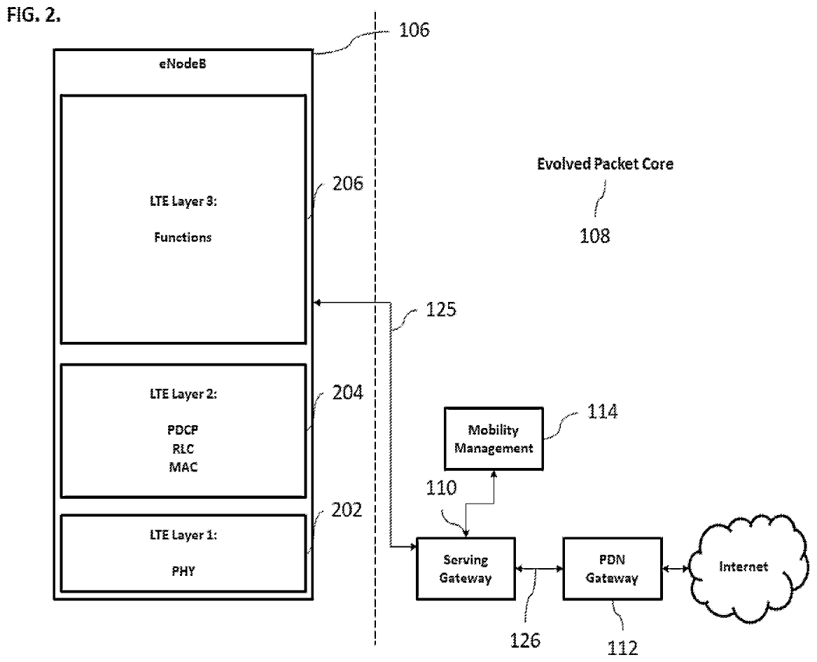

FIG. 2 illustrates an additional detail of an exemplary eNodeB 106. The eNodeB 106 includes a plurality of layers: LTE layer 1 202, LTE layer 2 204, and LTE layer 3 206. The LTE layer 1 includes a physical layer (“PHY”). The LTE layer 2 includes a medium access control (“MAC”), a radio link control (“RLC”), a packet data convergence protocol (“PDCP”). The LTE layer 3 includes various functions and protocols, including a radio resource control (“RRC”), a dynamic resource allocation, eNodeB measurement configuration and provision, a radio admission control, a connection mobility control, and radio resource management (“RRM”). The RLC protocol is an automatic repeat request (“ARQ”) fragmentation protocol used over a cellular air interface. The RRC protocol handles control plane signaling of LTE layer 3 between the user equipment and the EUTRAN. RRC includes functions for connection establishment and release, broadcast of system information, radio bearer establishment/reconfiguration and release, RRC connection mobility procedures, paging notification and release, and outer loop power control. The PDCP performs IP header compression and decompression, transfer of user data and maintenance of sequence numbers for Radio Bearers. The BBU 134, shown in FIG. 1d, can include LTE layers L1-L3.

One of the primary functions of the eNodeB 106 is radio resource management, which includes scheduling of both uplink and downlink air interface resources for user equipment 104, control of bearer resources, and admission control. The eNodeB 106, as an agent for the EPC 108, is responsible for the transfer of paging messages that are used to locate mobiles when they are idle. The eNodeB 106 also communicates common control channel information over the air, header compression, encryption and decryption of the user data sent over the air, and establishing handover reporting and triggering criteria. As stated above, the eNodeB 106 can collaborate with other eNodeB 106 over the X2 interface for the purposes of handover and interference management. The eNodeBs 106 communicate with the EPC's MME via the S1-MME interface and to the S-GW with the S1-U interface. Further, the eNodeB 106 exchanges user data with the S-GW over the S1-U interface. The eNodeB 106 and the EPC 108 have a many-to-many relationship to support load sharing and redundancy among MMEs and S-GWs. The eNodeB 106 selects an MME from a group of MMEs so the load can be shared by multiple MMEs to avoid congestion.

### II 5G NR Wireless Communications Networks

In some implementations, the current subject matter relates to a 5G new radio (“NR”) communications system. The 5G NR is a next telecommunications standard beyond the 4G/IMT-Advanced standards. 5G networks offer at higher capacity than current 4G, allow higher number of mobile broadband users per area unit, and allow consumption of higher and/or unlimited data quantities in gigabyte per month and user. This can allow users to stream high-definition media many hours per day using mobile devices, even when it is not possible to do so with Wi-Fi networks. 5G networks have an improved support of device-to-device communication, lower cost, lower latency than 4G equipment and lower battery consumption, etc. Such networks have data rates of tens of megabits per second for a large number of users, data rates of 100 Mb/s for metropolitan areas, 1 Gb/s simultaneously to users within a confined area (e.g., office floor), a large number of simultaneous connections for wireless sensor networks, an enhanced spectral efficiency, improved coverage, enhanced signaling efficiency, 1-10 ms latency, reduced latency compared to existing systems.

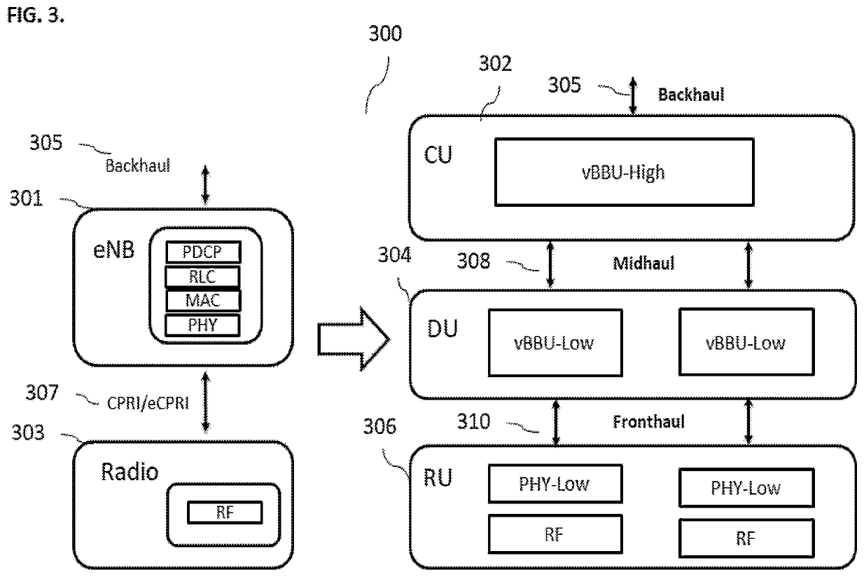

FIG. 3 illustrates an exemplary virtual radio access network 300. The network 300 can provide communications between various components, including a base station (e.g., eNodeB, gNodeB) 301, a radio equipment 303, a centralized unit 302, a digital unit 304, and a radio device 306. The components in the system 300 can be communicatively coupled to a core using a backhaul link 305. A centralized unit (“CU”) 302 can be communicatively coupled to a distributed unit (“DU”) 304 using a midhaul connection 308. The radio frequency (“RU”) components 306 can be communicatively coupled to the DU 304 using a fronthaul connection 310.

In some implementations, the CU 302 can provide intelligent communication capabilities to one or more DU units 304. The units 302, 304 can include one or more base stations, macro base stations, micro base stations, remote radio heads, etc. and/or any combination thereof.

In lower layer split architecture environment, a CPRI bandwidth requirement for NR can be 100s of Gb/s. CPRI compression can be implemented in the DU and RU (as shown in FIG. 3). In 5G communications systems, compressed CPRI over Ethernet frame is referred to as eCPRI and is the recommended fronthaul network. The architecture can allow for standardization of fronthaul/midhaul, which can include a higher layer split (e.g., Option 2 or Option 3-1 (Upper/Lower RLC split architecture)) and fronthaul with L1-split architecture (Option 7).

In some implementations, the lower layer-split architecture (e.g., Option 7) can include a receiver in the uplink, joint processing across multiple transmission points (TPs) for both DL/UL, and transport bandwidth and latency requirements for ease of deployment. Further, the current subject matter's lower layer-split architecture can include a split between cell-level and user-level processing, which can include cell-level processing in remote unit (“RU”) and user-level processing in DU. Further, using the current subject matter's lower layer-split architecture, frequency-domain samples can be transported via Ethernet fronthaul, where the frequency-domain samples can be compressed for reduced fronthaul bandwidth.

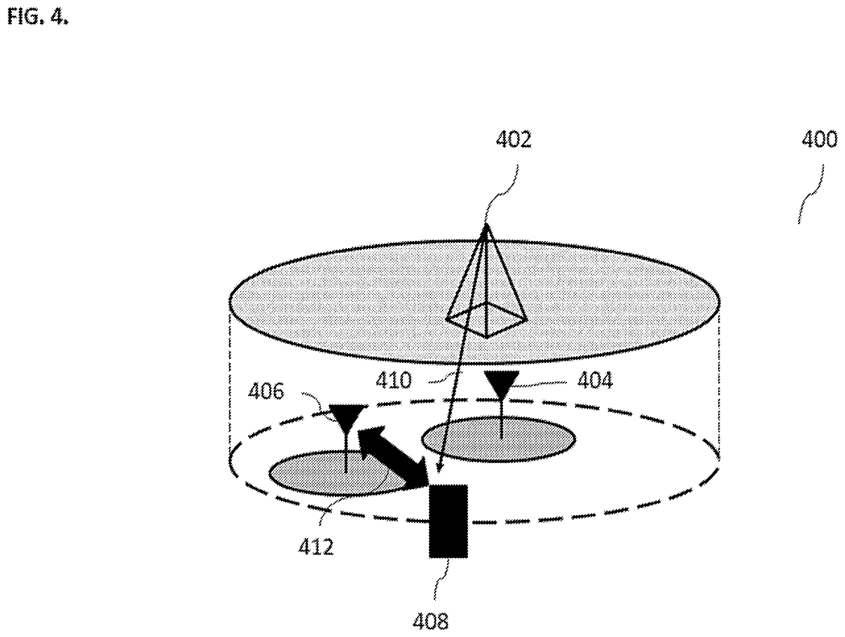

FIG. 4 illustrates an exemplary communications system 400 that can implement a 5G technology and can provide its users with use of higher frequency bands (e.g., greater than 10 GHz). The system 400 can include a macro cell 402 and small cells 404, 406.

A mobile device 408 can be configured to communicate with one or more of the small cells 404, 406. The system 400 can allow splitting of control planes (C-plane) and user planes (U-plane) between the macro cell 402 and small cells 404, 406, where the C-plane and U-plane are utilizing different frequency bands. In particular, the small cells 404, 406 can be configured to utilize higher frequency bands when communicating with the mobile device 408. The macro cell 402 can utilize existing cellular bands for C-plane communications. The mobile device 408 can be communicatively coupled via U-plane 412, where the small cell (e.g., small cell 406) can provide higher data rate and more flexible/cost/energy efficient operations. The macro cell 402, via C-plane 410, can maintain good connectivity and mobility. Further, in some cases, LTE and NR can be transmitted on the same frequency.

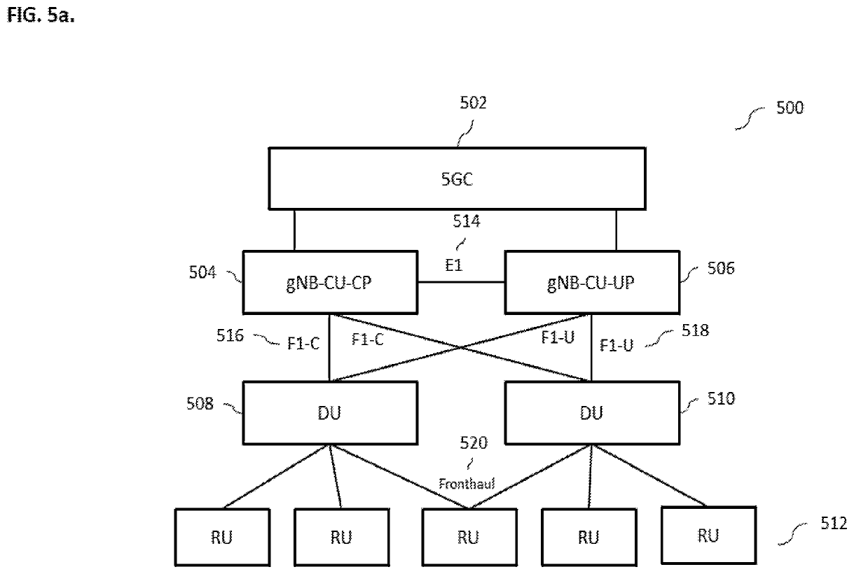

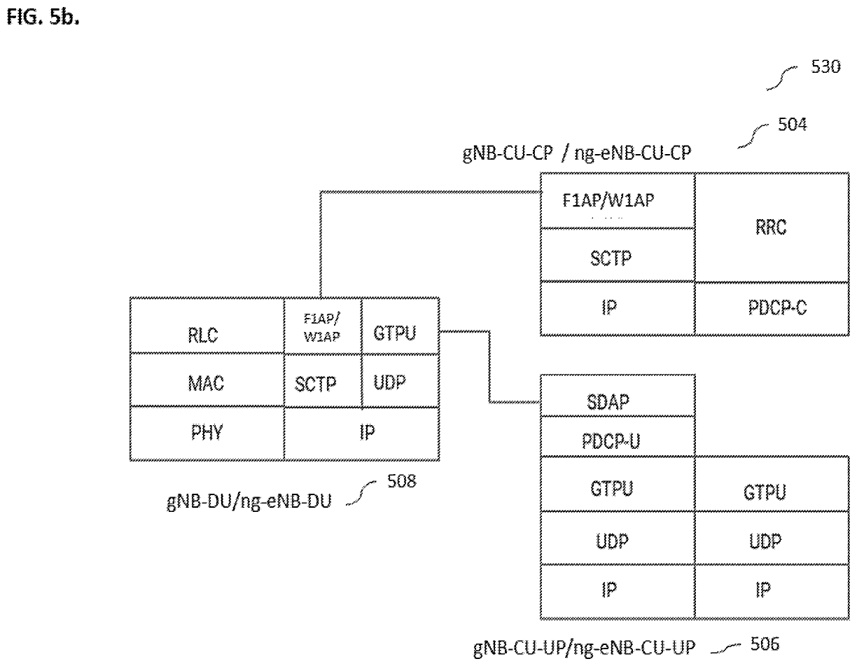

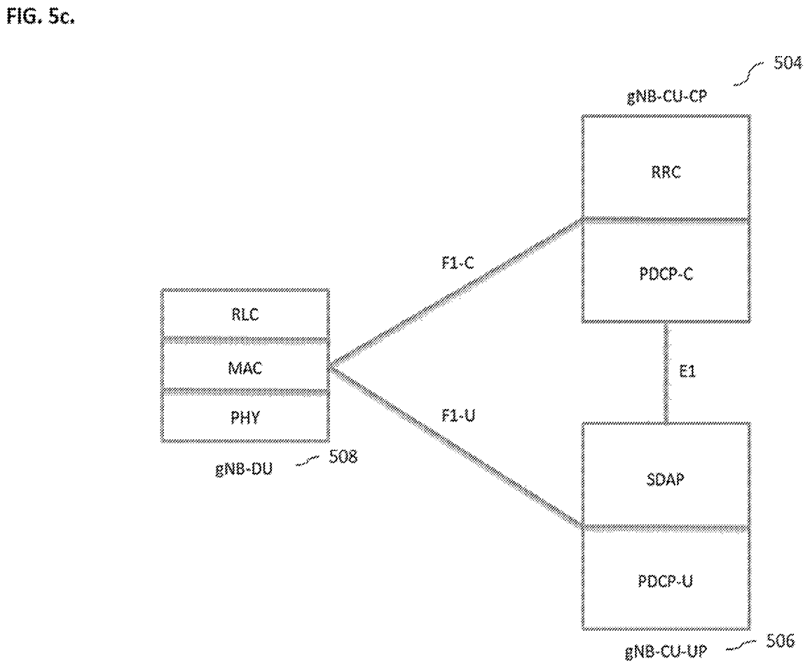

FIG. 5a illustrates an exemplary 5G wireless communication system 500, according to some implementations of the current subject matter. The system 500 can be configured to have a lower layer split architecture in accordance with Option 7-2. The system 500 can include a core network 502 (e.g., 5G Core) and one or more gNodeBs (or gNBs), where the gNBs can have a centralized unit gNB-CU. The gNB-CU can be logically split into control plane portion, gNB-CU-CP, 504 and one or more user plane portions, gNB-CU-UP, 506. The control plane portion 504 and the user plane portion 506 can be configured to be communicatively coupled using an E1 communication interface 514 (as specified in the 3GPP Standard). The control plane portion 504 can be configured to be responsible for execution of the RRC and PDCP protocols of the radio stack.

The control plane and user plane portions 504, 506 of the centralized unit of the gNB can be configured to be communicatively coupled to one or more distributed units (DU) 508, 510, in accordance with the higher layer split architecture. The distributed units 508, 510 can be configured to execute RLC, MAC and upper part of PHY layers protocols of the radio stack. The control plane portion 504 can be configured to be communicatively coupled to the distributed units 508, 510 using F1-C communication interfaces 516, and the user plane portions 506 can be configured to be communicatively coupled to the distributed units 508, 510 using F1-U communication interfaces 518. The distributed units 508, 510 can be coupled to one or more remote radio units (RU) 512 via a fronthaul network 520 (which may include one or switches, links, etc.), which in turn communicate with one or more user equipment (not shown in FIG. 5a). The remote radio units 512 can be configured to execute a lower part of the PHY layer protocols as well as provide antenna capabilities to the remote units for communication with user equipments (similar to the discussion above in connection with FIGS. 1a-2).

FIG. 5b illustrates an exemplary layer architecture 530 of the split gNB. The architecture 530 can be implemented in the communications system 500 shown in FIG. 5a, which can be configured as a virtualized disaggregated radio access network (RAN) architecture, whereby layers L1, L2, L3 and radio processing can be virtualized and disaggregated in the centralized unit(s), distributed unit(s) and radio unit(s). As shown in FIG. 5b, the gNB-DU 508 can be communicatively coupled to the gNB-CU-CP control plane portion 504 (also shown in FIG. 5a) and gNB-CU-UP user plane portion 506. Each of components 504, 506, 508 can be configured to include one or more layers.

The gNB-DU 508 can include RLC, MAC, and PHY layers as well as various communications sublayers. These can include an F1 application protocol (F1-AP) sublayer, a GPRS tunneling protocol (GTPU) sublayer, a stream control transmission protocol (SCTP) sublayer, a user datagram protocol (UDP) sublayer and an internet protocol (IP) sublayer. As stated above, the distributed unit 508 may be communicatively coupled to the control plane portion 504 of the centralized unit, which may also include F1-AP, SCTP, and IP sublayers as well as radio resource control, and PDCP-control (PDCP-C) sublayers. Moreover, the distributed unit 508 may also be communicatively coupled to the user plane portion 506 of the centralized unit of the gNB. The user plane portion 506 may include service data adaptation protocol (SDAP), PDCP-user (PDCP-U), GTPU, UDP, and IP sublayers.

FIG. 5c illustrates an exemplary functional split in the gNB architecture shown in FIGS. 5a-b. As shown in FIG. 5c, the gNB-DU 508 may be communicatively coupled to the gNB-CU-CP 504 and gNB-CU-UP 506 using an F1-C communication interface. The gNB-CU-CP 504 and gNB-CU-UP 506 may be communicatively coupled using an E1 communication interface. The higher part of the PHY layer (or Layer 1) may be executed by the gNB-DU 508, whereas the lower parts of the PHY layer may be executed by the RUs (not shown in FIG. 5c). As shown in FIG. 5c, the RRC and PDCP-C portions may be executed by the control plane portion 504, and the SDAP and PDCP-U portions may be executed by the user plane portion 506.

Some of the functions of the PHY layer in 5G communications network can include error detection on the transport channel and indication to higher layers, FEC encoding/decoding of the transport channel, hybrid ARQ soft-combining, rate matching of the coded transport channel to physical channels, mapping of the coded transport channel onto physical channels, power weighting of physical channels, modulation and demodulation of physical channels, frequency and time synchronization, radio characteristics measurements and indication to higher layers, MIMO antenna processing, digital and analog beamforming, RF processing, as well as other functions.

The MAC sublayer of Layer 2 can perform beam management, random access procedure, mapping between logical channels and transport channels, concatenation of multiple MAC service data units (SDUs) belonging to one logical channel into transport block (TB), multiplexing/demultiplexing of SDUs belonging to logical channels into/from TBs delivered to/from the physical layer on transport channels, scheduling information reporting, error correction through HARQ, priority handling between logical channels of one UE, priority handling between UEs by means of dynamic scheduling, transport format selection, and other functions. The RLC sublayer's functions can include transfer of upper layer packet data units (PDUs), error correction through ARQ, reordering of data PDUs, duplicate and protocol error detection, re-establishment, etc. The PDCP sublayer can be responsible for transfer of user data, various functions during re-establishment procedures, retransmission of SDUs, SDU discard in the uplink, transfer of control plane data, and others.

Layer 3's RRC sublayer can perform broadcasting of system information to NAS and AS, establishment, maintenance and release of RRC connection, security, establishment, configuration, maintenance and release of point-point radio bearers, mobility functions, reporting, and other functions.

### III. Transport Network Domain Slicing Architecture

In some implementations of the current subject matter, a transport network domain slicing performance monitoring, analytics and SLA assurance based on AI/ML is provided. A network slice architecture includes NSMF or NSC/TN domain manager integration with the AI/ML. The NSMF or NSC/TN domain manager is associated with other northbound interfaces and with REST-API interfaces between the NSC and the NSMF. The AI/ML integration is used for monitoring and analyzing TN domain slicing performance and generating necessary actions to optimize and assure E2E network slicing SLA from the TN domain aspect.

A granular control on the existing end-to-end slicing architecture is performed, where SLA deviations and performance of the logical dedicated forwarding plane in the transport domain can be detected and informed to a network service provider. Thus, customer services across telecommunications operators (telcos) may be improved and/or ensuring foolproof network slicing deployment across telcos may be improved.

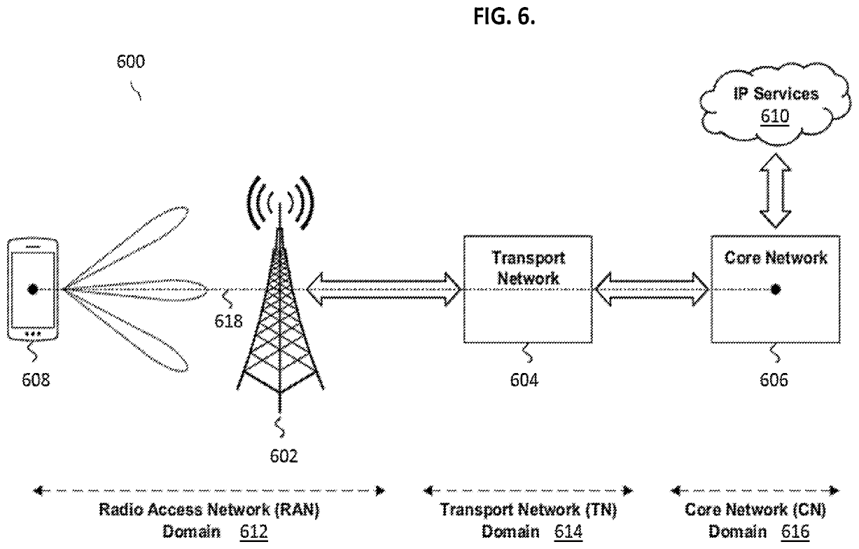

FIG. 6 illustrates an implementation of a wireless communications system 600 that can include a TN domain slicing architecture as described herein. The wireless communications system 600 includes at least one base station 602 (e.g., eNodeB 106 of FIGS. 1b-2, gNodeB of FIG. 5a, a next generation RAN (NG-RAN) node such as an eNodeB or a gNodeB, etc.), at least one transport network 604, and at least one core network 606 (e.g., the 5GC 502 of FIG. 5a, etc.). At least one UE 608 can access the at least one core network 606 and/or IP services 610 via a connection to the one or more base stations 602 over a RAN domain 612 and through the at least one transport network 604. The one or more base stations 602 can be configured to wirelessly communicate with the one or more UEs 608 over the RAN domain 612. Examples of UEs include a cellular phone, a smart phone, a session initiation protocol (SIP) phone, a laptop, a personal digital assistant (PDA), a satellite radio, a global positioning system (GPS), a multimedia device, a video device, a digital audio player (e.g., MP3 player, etc.), a camera, a game console, a tablet, a smart device, a wearable device, a vehicle, an electric meter, a gas pump, a large or small kitchen appliance, a healthcare device, an implant, a sensor/actuator, a display, or any other similarly functioning device. A UE can be an Internet-of-Things (IoT) device (e.g., parking meter, gas pump, toaster, vehicles, heart monitor, etc.).

The one or more base stations 602 can be configured to interface (e.g., establish connections, transfer data, and the like) with the at least one core network 606 through the at least one transport network 604. The transport network 604 can transfer data (e.g., uplink data, downlink data) and/or signaling between the RAN domain 612 and a core network (CN) domain 616. For example, the at least one transport network 604 can provide one or more backhaul links between the one or more base stations 602 and the at least one core network 606. The backhaul links may be wired or wireless.

The core network 606 can be configured to provide one or more services (e.g., enhanced mobile broadband (eMBB), ultra-reliable low-latency communications (URLLC), and massive machine type communications (mMTC), etc.) to the one or more UEs 608 connected to the RAN domain 612 via a transport network (TN) domain 614. Alternatively or additionally, the core network 606 can be configured to serve as an entry point for the IP services 610. The IP services 610 can include the Internet, an intranet, an IP multimedia subsystem (IMS), a streaming service (e.g., video, audio, gaming, etc.), and/or other IP services.

An end-to-end network slice 618 can be configured to provide a required connectivity between the at least one UE 608 and the core network 606 with a specified performance commitment. The end-to-end network slice 618 generally refers to a logical network topology connecting a number of endpoints (e.g., the at least one UE 608, the core network 608) using a set of shared or dedicated network resources (e.g., the at least one base station 602, the at least one transport network 604) that are used to satisfy a specific performance commitment. The performance commitments that are to be satisfied by the end-to-end network slice 618 can be referred to as service level agreements (SLAs), service level objectives (SLOs), service level expectations (SLEs), and/or service level indicators (SLIs). Examples of these performance commitments can include, but are not limited to, a guaranteed minimum bandwidth (e.g., bandwidth between two end points in a particular direction), a guaranteed maximum latency (e.g., network latency when transmitting between two endpoints), a maximum permissible delay variation (PDV) (e.g., a maximum difference in a one-way delay between sequentially transmitted packets in a flow), a maximum permissible packet loss rate (e.g., a ratio of packets dropped to packets transmitted), and a minimum availability ratio (e.g., a ratio of uptime to the sum of uptime and downtime).

The at least one UE 608 can be configured to access multiple network slices 618 over the one or more base stations 602. In some implementations, each network slice 618 can be configured to serve a particular service type with a specified performance commitment.

Each network slice 618 can be identified by a global identifier. The global identifier can be used by the RAN domain 612, the TN domain 614, and the CN domain 616 to identify the network slice 618. The global identifier can be, e.g., a single network slice selection assistance information (S-NSSAI). The S-NSSAI can include information regarding a slice and/or service type (SST), which can indicate an expected behavior of the particular network slice in terms of features and/or services. The S-NSSAI can also include a slice differentiator (SD), which can allow for further differentiation for selecting a network slice instance from one or more network slice instances that may comply with the indicated SST. Alternatively or additionally, the SST and/or the SD can use standard values and/or can use values specific to a particular network provider (e.g., public land mobile network (PLMN)).

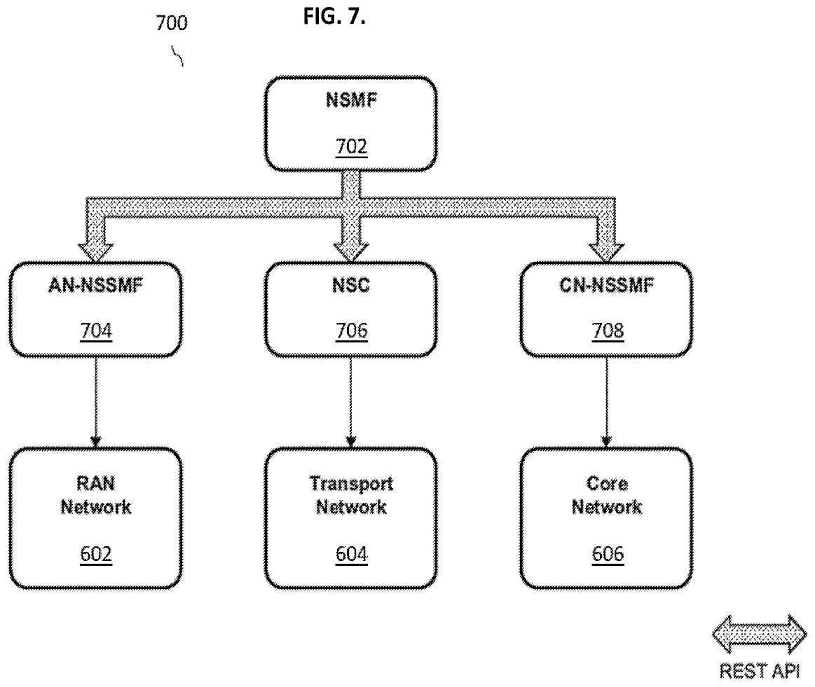

FIG. 7 illustrates an implementation of a high-level network slice architecture 700 in a wireless communications system. The high-level network slice architecture 700 can be implemented by and/or be included with the LTE communication system 100 of FIG. 1a, the communications system 400 of FIG. 4, the 5G wireless communication system 500 of FIG. 5a, the wireless communications system 600 of FIG. 6, or other communications system. The network slice architecture 700 of FIG. 7 is illustrated with respect to the wireless communications system 600 of FIG. 6 for ease of explanation but can be similarly implemented using another wireless communications system.

As shown in FIG. 7, the high-level network slice architecture 700 includes a network slice management function (NSMF) 702. The network slice management function (NSMF) 702 can be configured to request each domain (e.g., RAN, TN, and CN domains) of the network architecture to create a portion (e.g., subnet) of the network slice 618 in each network domain 612, 614, 616. The network slice 618 can be implemented by a combination of subnets created within each domain 612, 614, 616 of the network to establish the communication path across the communications system. The NSMF 702 can be configured to generate a global identifier, such as an S-NSSAI, that uniquely identifies the network slice 618. Alternatively or additionally, the NSMF 702 can be configured to create one or more service profiles requesting dedicated resources for the network slice 618 in each network domain 612, 614, 616. The service profiles can be determined according to one or more services to be provided over the network slice 618 and/or the specified performance commitments of the network slice 618.

In some implementations, the NSMF 702 can be configured use a representational state transfer application programming interface (REST-API) to request each of the domains 612, 614, 616 to create their respective portions of the network slice 618. Alternatively or additionally, the NSMF 702 can be configured transmit and/or send a message comprising the slice creation request to a network element corresponding to each of the network domains 612, 614, 616.

As shown in the implementation of FIG. 7, each of the RAN, TN, and CN domains 612, 614, 616 of the network architecture 700 can include an independent network slicing management function. As shown in this illustrated implementation, the independent network slicing management functions can include an access network-network slice subnet management function (AN-NSSMF) 704, a transport network-network slice subnet management function (TN-NSSMF) 706, such as a network slice controller (NSC) or a TN domain manager or orchestrator, and a core network-network slice subnet management function (CN-NSSMF) 708. These management functions can be configured to manage or orchestrate their respective portions of the network slice 618 without coordination and/or cooperation among them. The AN-NSSMF 704 can include a RAN domain management function configured to manage the RAN network 602, the TN-NSSMF 706 can include a TN domain management function configured to manage the TN 604, and the CN-NSSMF 708 can include a CN domain management function configured to manage the CN 606.

The NSMF 702 can be configured to transmit a network slice creation request to each of the AN-NSSMF 704, the NSC 706, and the CN-NSSMF 708 so the AN-NSSMF 704, the NSC 706, and the CN-NSSMF 708 can reserve resources for the network slice 618 in their respective associated domains 612, 614, 616. The NSMF 702 can be configured to send a slice creation request to the AN-NSSMF 704, such as a RAN path computation element and/or a RAN orchestrator, to create the RAN domain portion of the network slice 618. For example, the slice creation request transmitted by the NSMF 702 to the AN-NSSMF 704 can include the S-NSSAI (or other global identifier) identifying the network slice 618 and/or the service profile determined for the RAN domain 612. In response to receiving the slice creation request from the NSMF 702, the AN-NSSMF 704 can be configured to allocate one or more resources (e.g., time periods, frequency ranges, bandwidths, etc.) of the RAN domain 612 for the network slice 618. That is, the AN-NSSMF 704 can be configured to configure one or more base stations 602 of the RAN domain 612 and/or other network elements of the RAN domain 612 to provide a network path between the at least one UE 608 and the transport network 604 according to the performance commitments specified for the network slice 618. Alternatively or additionally, the AN-NSSMF 704 can be configured to further allocate the RAN resources according to other performance factors such as, but not limited to, available processing throughput of allocated devices, latency considerations, geographical location of allocated devices, priority of services associated with the network slice 618, and the like.

The NSMF 702 can be configured to send a slice creation request to the CN-NSSMF 708, such as a CN path computation element and/or a CN orchestrator, to create the CN domain portion of the network slice 618. For example, the slice creation request transmitted by the NSMF 702 to the CN-NSSMF 708 can include the S-NSSAI (or other global identifier) identifying the network slice 618 and/or the service profile determined for the CN domain 616. In response to receiving the slice creation request from the NSMF 702, the CN-NSSMF 708 can be configured to compute and/or allocate one or more core network paths for the network slice 618 to provide a network path between the at least one UE 908 and one or more services indicated by the slice creation request. For example, the CN-NSSMF 708 can be configured to select core network paths based at least on a source address indicated by the slice creation request, a destination address indicated by the slice creation request, and/or network path constraints (e.g., service profile, performance commitments, etc.) indicated by the slice creation request. Alternatively or additionally, the CN-NSSMF 708 can be configured to configure one or more network elements of the CN network 606 to provide the one or more services indicated by the slice creation request to the at least one UE 608, according to the performance commitments specified for the network slice 618.

The NSMF 702 can be configured to send a slice creation request to the TN-NSSMF 706, such as an network slice controller (NSC) and/or a TN domain manager or orchestrator, to create the TN domain portion of the network slice 618. For example, the slice creation request sent by the NSMF 702 to the TN-NSSMF 706 can include the S-NSSAI (or other global identifier) identifying the network slice 618 and/or the service profile determined for the TN domain 614. In response to receiving the slice creation request from the NSMF 702, the TN-NSSMF 706 can be configured to compute and/or allocate one or more transport network paths for the network slice 618. For example, the TN-NSSMF 706 can be configured to select transport network paths based at least on a source address indicated by the slice creation request, a destination address indicated by the slice creation request, and/or network path constraints (e.g., service profile, performance commitments, etc.) indicated by the slice creation request. Alternatively or additionally, the TN-NSSMF 706 can be configured to configure one or more network elements of the TN network 604 to provide the one or more transport network paths between the RAN domain 612 and the core network 606 according to the performance commitments specified for the network slice 618.

Aspects of slice creation and reserving resources in the RAN and CN domains 612, 616 are defined by standards, e.g., by standards of 3GPP and IETF. However, aspects of slice creation and reserving resources in the TN domain 614 are not defined by standards, e.g., by standards of 3GPP and IETF. For example, network slicing has been addressed by 3GPP in 3GPP TS 28.531 and 3GPP TS 28.533 and by IETF in Traffic Engineering Architecture and Signaling (TEAS) IETF working group (WG) documentations, such as the TEAS-IETF WG Framework for IETF Network Slices, but none of then cover the impact on end-to-end (E2E) SLAs due to performance deviations in the transport domain.

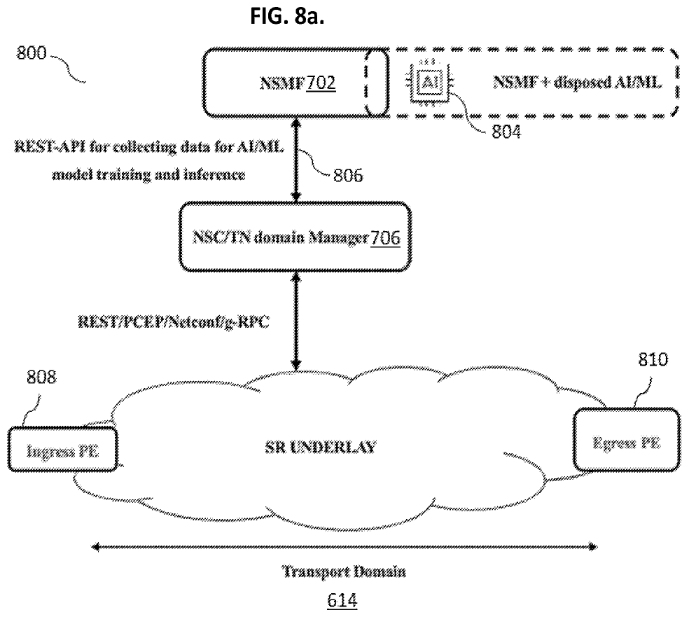

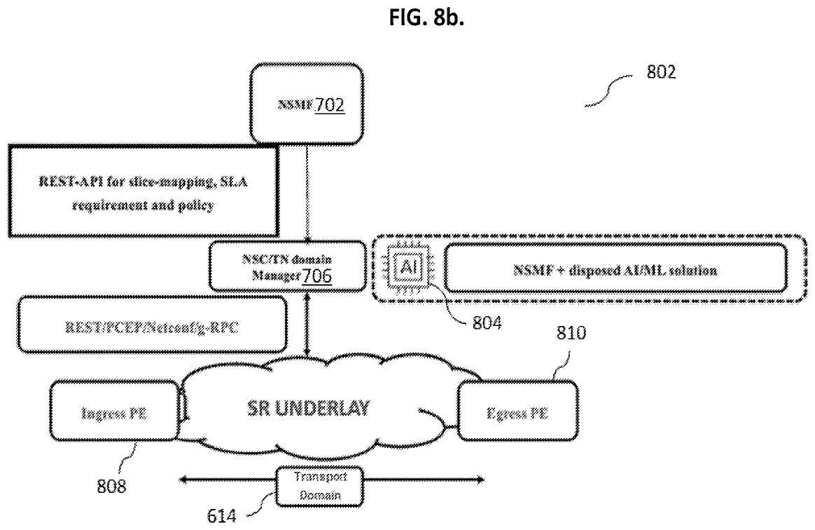

The network slice architectures described herein, such as the network slice architectures 800, 802 illustrated in FIGS. 8a and 8b and discussed further below, may allow for resource utilization of Dedicated Forwarding Planes (DFPs) in the TN domain and track the SLA violations due to performance failures.

Nowadays, Internet of Things (IoT) is used for performing domain slicing using a DFP architecture. Transport domain slices are deployed using the DFP architecture. Each DFP is based on per application. The slicing forwarding planes are logical to deliver virtual resources from physical network resources. For example, one DFP is based on an Enhanced mobile broadband (e-MBB) application slice, and another could be based on an Ultra reliable low latency (uRLLC) or IoT Slices. DFPs are assigned either using an existing mechanism, for example a Flex-Algo mechanism based architecture, which partitions the physical network resources into multiple logical resources by assigning dedicated forwarding algorithms, or by creating multiple Virtual Local Area Network (VLAN)-based logical interfaces with own given Quality of Service (QoS) and Infra resources or else by creating segment routing (SR) traffic engineering policy.

In a first scenario, DFP performance measurement in a transport domain is a crucial challenge for the telcos and operators offering end-to-end network slicing solutions that include RAN, transport, and core domains. A downside of the transport domain slicing architecture for the telcos/operator is how to track the resource utilization of DFPs before it reaches the limit where a slicing application starts to suffer due to either overconsumption of the logical resources or performance impacts due to the following reasons: device malfunctioning, software bugs, and distributed denial-of-service (DDoS) attacks on the network infrastructure.

A second scenario in an end-to-end slicing architecture is SLA monitoring and assurance of DFP performance. During the DFP performance impacts, the SLA of the end-to-end slices may be violated, which can impact the overall network slicing applications. Such violations remain agnostic in the slicing architecture defined by 3GPP in 3GPP TS 28.531 and 3GPP TS 28.533. There is not currently a mechanism defined by 3GPP to monitor the transport domain SLAs from UE to a User Plane Function (UPF) and allow network slice management systems to make SLA assurance actions to the transport domain of the network. Currently, with the increased use of server clusters, network operators need to improve and optimize energy efficiency and minimize power consumption.

Current methods improve efficiency to either use a first-fit or best-fit algorithms in order to place an incoming application on a target cluster or node. For example, one conventional method is to place the incoming application, task, job, operation, or program on the first available cluster and node that matches the resource requirements of the incoming application. However, a drawback of this method is that energy efficiency is not optimized if a resource hungry cluster or node is utilized. The transport network domain slicing architecture described herein may alleviate this drawback.

FIGS. 8a and 8b illustrate various implementations of network slice architectures that include NSMF or NSC/TN domain manager integration with AI/ML. The implementations of FIGS. 8a and 8b are described with respect to the wireless communications system 600 of FIG. 6 and the network slice architecture 700 of FIG. 7 but can be similarly implemented by and/or be included with other wireless communications systems, as also mentioned above. As mentioned above, the AI/ML integration can be used for monitoring and analyzing TN domain slicing performance and generating necessary actions to optimize and assure E2E network slicing SLA from the TN domain aspect.

Integrating the AI/ML with the NSC/TN domain manager may provide for less latency than integrating the AI/ML with the NSMF because the NSC/TN domain manager is closer to the underlying network, as shown in FIG. 7. Integrating the AI/ML with the NSC/TN domain manager may thus also save bandwidth in transporting data than integrating the AI/ML with the NSMF because the NSC/TN domain manager is closer to the underlying network.

Integrating the AI/ML with the NSMF may be easier to implement than integrating the AI/ML with the NSC/TN domain manager because network information is traditionally available to the NSMF, e.g., because the NSMF is communicatively coupled to the RAN, TN, and CN domains whereas the NSC/TN domain manager is communicatively coupled to the TN domain but not to the RAN and CN domains, as shown in FIG. 7. Thus, if the AI/ML is integrated with the NSC/TN domain manager, at least some network information may need to be provided to the NSC/TN domain manager, unlike if the AI/ML is integrated with the NSMF.

FIG. 8a illustrates an exemplary implementation of a network slice architecture 800 incorporating AI/ML 804 (e.g., AI/ML model or algorithms stored in a memory and executable by a processor) in the NSMF 702. The AI/ML 804 is thus deployed in the NSMF 702 in this implementation. The AI/ML 804 integrated with the NSMF 702 can be deployed inside the NSMF 702 or can run on an external application server. A RESTful interface (REST-API interface) 806 between the NSMF 702 and the NSC 706 allows for collecting input data to the AI/ML 804 at the NSMF 702 for AI/ML workflow, such as model training and inference.

The AI/ML 804 is configured to track performance status of DFPs and monitor if specific SLAs of end-to-end network slices are met from a TN domain viewpoint. The AI/ML 804 is configured to generate performance scores of TN slices after evaluating performance of the DFPs (logical forwarding resources) and SLAs met/deviated per logical/slicing topology.

Low-performance scores on TN slicing could be either SLA violations or bad performance indicators. The administrator/operator or the slice management systems, the NSMF 702, can be configured to use the reports to take at least one corrective action, which could be creating either a new forwarding plane as desired by the application in the network or assigning additional networks as desired by the slicing applications.

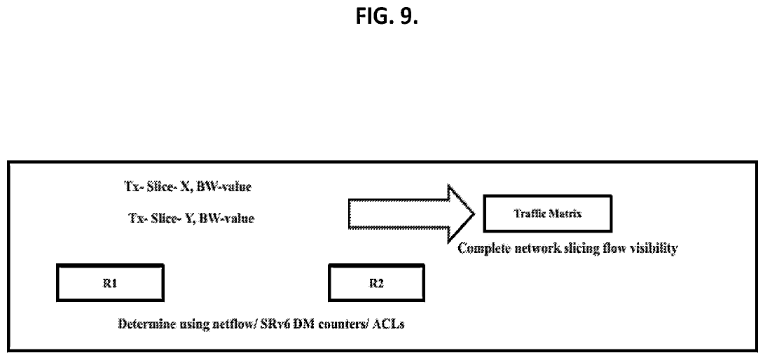

The AI/ML 804 can be configured to use input data available either within the NSMF 702 or collected at the NSMF 702 from the NSC 706 and TN 604 to derive performance score and network slice SLA assurance decisions. Examples of the input data include:
1) data mapping between aggregation of RAN and core slices with S-NSSAI and transport slice identifiers (Tx-Slice-ID). Implementations of data mapping between aggregation of RAN and core slices with S-NSSAI and transport slice identifiers are discussed further, for example, in International Patent Application No. PCT/US22/28951 entitled “Transport Slice Identifier For End-To-End Network Slicing Mapping” filed May 12, 2022, which is hereby incorporated by reference in its entirety for all purposes.
2) data mapping between Tx-Slice-ID and logical DFPs paths used in the network. Implementations of data mapping between Tx-Slice-ID and logical DFPs paths used in the network are discussed further, for example, in previously mentioned International Patent Application No. PCT/US22/28951 entitled “Transport Slice Identifier For End-To-End Network Slicing Mapping” filed May 12, 2022.
3) telemetry data that provides health of a forwarding plane such as central processing unit (CPU) consumption, memory utilization, route limits, mac limits etc. per each DFP. Telemetry is a well-known mechanism for automatic recording and transmission of data from remote system/nodes to the monitoring system.
4) traffic matrices that provide bandwidth consumption of all the slicing flows for each transport link. The traffic matrices can be used to determine bandwidth usage SLAs. FIG. 9 illustrates an implementation of a traffic matrix label, according to some implementations of the currently subject matter. A traffic matrix can be used to determine the per flow bandwidth at transport network network-to-network interfaces (NNIs). At given interface level, as shown in FIG. 9 between R1 and R2 using segment routing accounting features (e.g., segment routing over IPv6 (SRv6) DM counters) or NetFlow or access list counters (ACL), a given node can identify the slicing flows and bandwidth usage.
5) SRv6 transport network performance management (SRv6-PM) reports, which are probes sent by an ingress provider edge (PE) 808, which is a node connected to the RAN domain 612, to an egress PE 810, which is anode connected to the core domain 616, to determine latency, packet drops, and packet delay variations.

In some implementations, all five types of the input data 1)-5) are used by the AI/ML 804. The five types of the input data 1)-5) can be the only input data used by the AI/ML 804, or one or more additional types of input data can be used by the AI/ML 804. In some implementations, less than all five types of the input data 1)-5) are used by the AI/ML 804. One, two, three, or four types of the input data 1)-5) can be used by the AI/ML 804 with or without one or more additional types of input data.

Integrating the NSMF 702 and the AI/ML 804 as shown in FIG. 8a can provide the AI/ML 804 with input data including the required SLAs assigned to each S-NSSAI ID. Using this information, the AI/ML 804 will be aware of the actual slicing SLA requested by the application. The interface between NSC 706 and the AI/ML 804, e.g., the REST-API interface 806, allows the AI/ML 804 to know the status of the transport domain slicing performance (e.g., health of DFPs and SLA accomplished with the Tx-Slice-ID and its mapping with S-NSSA ID) in the transport domain 614. Using this framework, the AI/ML 804 can determine if the transport domain slicing model meets the requirement of actual end-to-end SLA between the UE 608 and UPF and if the transport domain slicing model complies with the overall SLA objectives. The AI/ML 804 can use this information to train the AI/ML model to predict transport domain network slicing performance indicators. The transport domain slicing performance scores can be viewed as an indicator for corrective action and more visibility into the end-to-end slicing model.

FIG. 8b illustrates an exemplary implementation of a network slice architecture 800 incorporating the AI/ML 804 in the NSC/TN domain manager 706. The AI/ML 804 is thus deployed in the NSC/TN domain manager 706 (e.g., in the NSC, the TN domain manager, or in both the NSC, the TN domain manager) in this implementation. The AI/ML 804 integrated with the NSC/TN domain manager 706 can be deployed inside the NSC/TN domain manager 706 or can run on an external application server. The RESTful interface (REST-API interface) 806 between the NSMF 702 and the NSC 706 allows the NSC 706 to collect input data from the NSMF 702, such as slice-mapping and application SLA information from the NSMF 702. The NSMF 706 can also give high-level policy guidance to the TN domain manager/NSC 706 via the REST-API interface 806 to influence the TN domain slice management from a high-level by taking into account full pictures of the network E2E slice environment.

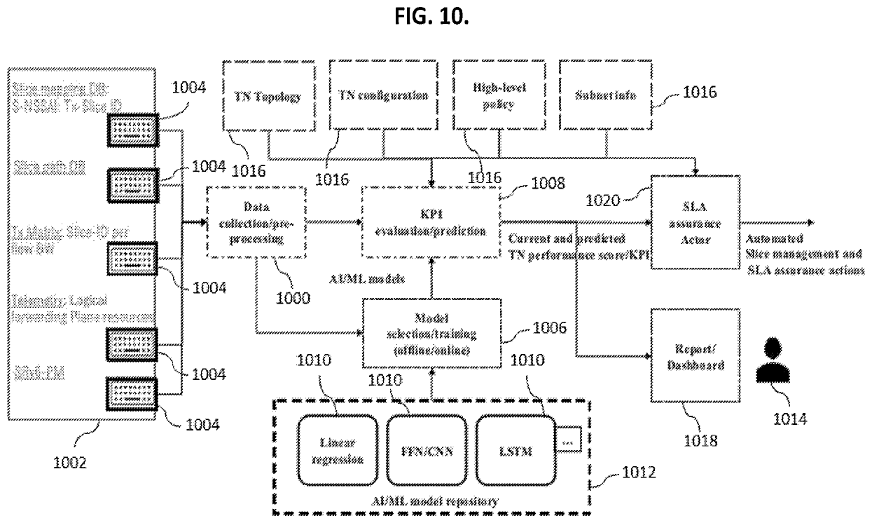

FIG. 10 illustrates an exemplary implementation of the AI/ML 804 configured to be integrated and running in the NSMF 702 (FIG. 8a) or in the NSC 706 (FIG. 8b) and configured to provide transport network domain slicing performance monitoring, analytics and SLA assurance, according to the various implementations disclosed herein. The AI/ML 804 includes a data collection/pre-processing module 1000 configured to receive input data 1002 via at least one port 1004. The input data 1002 shown in FIG. 10 includes the five types of data 1)-5) discussed above. Thus, five ports 1004 are shown in FIG. 10 with each port 1004 configured to communicate one of the input data 1002. The data collection/pre-processing module 1000 is configured to collect the input data 1002 from the network and pre-process the collected input data. The data collection/pre-processing performed by the data collection/pre-processing module 1000 can be performed in accordance with standard data processing techniques.

The data collection/pre-processing module 1000 is configured to deliver structured data packets ready to be processed by AI/ML to a model selection/training module 1006 of the AI/ML 804 for AI/ML model training. The training performed by the model selection/training module 1006 can happen either offline or online.

The model selection/training module 1006 is configured to select one AI/ML model from a plurality of AI/ML models 1010 stored in a AI/ML model repository 1012 accessible to the model selection/training module 1006. Three types of AI/ML models 1010 are shown in FIG. 10 (a linear regression model, a Feed Forward Network (FFN)/Convolutional Neural Network (CNN) model, and a Long Short-Term Memory (LSTM) model), but the AI/ML model repository 1012 can include less than three types of AI/ML models or can include more than three types of AI/ML models. Additionally, the AI/ML models 1010 stored in the AI/ML model repository 1012 can include zero, one, two, or three of the linear regression, FFN/CNN, and LSTM AI/ML model types shown in FIG. 10. In some implementations, CNN can be used by the AI/ML 804 for classification and pattern recognition works that derives a performance score by recognizing patterns hidden in the input data and classifying performance levels. In some implementations, for prediction work, the AI/ML 804 can use either the linear regression model for simplicity or FFN and the LSTM model for strong prediction performance and accuracy at the cost of complexity.

The model selection/training module 1006 can select one of the AI/ML models 1010 in any of a variety of ways. In some implementations of the current subject matter, the model selection/training module 1006 can select one of the AI/ML models 1010 at random. In some implementations of the current subject matter, a user (e.g., user 1014) can input initial configuration requirements (e.g., target performance/accuracy desired to achieve, etc.) to the AI/ML 804 via the NSMF 702 (FIG. 8a) or the NSC 706 (FIG. 8b). The model selection/training module 1006 can be configured to select one of the AI/ML models 1010 based on the initial configuration requirements. In implementations in which the AI/ML model repository 1012 includes only one AI/ML model, the model selection/training module 1006 can be configured to select the one of the AI/ML models 1010 without regard to any input initial configuration requirements.

The model selection/training module 1006 is configured to deliver the trained, selected AI/ML model 1010 to a key performance indicator (KPI) evaluation/prediction module 1008 of the AI/ML 804. The data collection/pre-processing module 1000 is configured to deliver the structured data packets to the KPI evaluation/prediction module 1008. The KPI evaluation/prediction module 1008 thus has data to evaluate and an AI/ML model with which to perform the evaluation. The KPI evaluation/prediction module 1008 also has access to top level network configuration information 1016, e.g., data stored in one or more databases, one or more memories, etc., so the KPI evaluation/prediction module 1008 is aware of configuration parameters of the network. The top level network configuration information 1016 in this illustrated implementation includes TN topology information, TN configuration information, high-level policy information, and subnet information. Four types of top level network configuration information 1016 are shown in FIG. 10, but the top level network configuration information 1016 can include less than four types of top level network configuration information or can include more than four types of top level network configuration information. Additionally, the top level network configuration information 1016 available to the KPI evaluation/prediction module 1008 can include zero, one, two, three, or four of the four types of top level network configuration information shown in FIG. 10.

The KPI evaluation/prediction module 1008 is configured to use the AI/ML model 1010 received from the model selection/training module 1006 in evaluating the data received from the data collection/pre-processing module 1000 to generate performance scores of TN slices after evaluating the performance of the DFPs (logical forwarding resources) and SLAs met/deviated per logical/slicing topology. Low-performance scores on TN slicing could be either SLA violations or bad performance indicators.

The KPI evaluation/prediction module 1008 can also be configured to predict future performance of the DFPs and SLAs based on historical data input for making proactive actions.

The KPI evaluation/prediction module 1008 is configured to provide the evaluated (current) and predicted (future) performance scores and KPIs to a dashboard or reporting/logging subsystem 1018 for the user 1014 (e.g., an administrator, an operator, etc.). Providing the evaluated and predicted performance scores and KPIs to the dashboard or reporting/logging subsystem 1018 allows a user to take a corrective action is needed. The corrective action can be, for example, creation of either a new forwarding plane as desired by the application in the network or assigning additional networks as desired by the slicing applications.

The KPI evaluation/prediction module 1008 is configured to provide the evaluated (current) and predicted (future) performance scores and KPIs to an SLA assurance actor 1020. The SLA assurance actor 1020 is configured to generate automated slice management and SLA assurance actions.

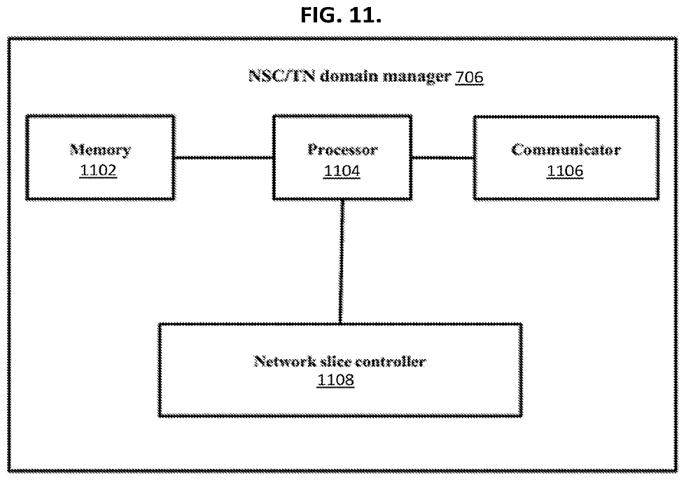

FIG. 11 illustrates an implementation of a UE 1100 configured for transport network domain slicing performance monitoring, analytics and SLA assurance based on AI/ML, according to the implementations disclosed herein. As shown in FIG. 11, the UE 1100 can include at least one storage device or memory 1102, at least one processor 1104, at least one communicator 1106, and at least one network slice controller 1108.

The memory 1102 is configured to store instructions to be executed by the processor 1104. The memory 1102 can include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 1102 may, in some examples, be considered a non-transitory storage medium. The term “non-transitory” may indicate that the storage medium is not embodied in a carrier wave or a propagated signal. However, the term “non-transitory” should not be interpreted that the memory 1102 is non-movable. In some examples, the memory 1102 is configured to store larger amounts of information. In certain examples, a non-transitory storage medium may store data that can, over time, change (e.g., in Random Access Memory (RAM) or cache).

The processor 1104 can be a general-purpose processor, such as a CPU, an application processor (AP), or the like, a graphics-only processing unit such as a graphics processing unit (GPU), a visual processing unit (VPU), and/or an AI-dedicated processor such as a neural processing unit (NPU). The processor 1104 can include multiple cores and is configured to execute the instructions stored in the memory 1102.

The communicator 1106 is configured to communicate internally between internal hardware components of the user equipment 1100 and with external devices via one or more networks. The communicator 1106 can include an electronic circuit specific to a standard that enables wired or wireless communication.

The network slice controller 1108 is configured to include AI/ML as described herein (e.g., the AI/ML 804, etc.) for monitoring and analyzing TN domain slicing performance and generating any necessary corrective actions to optimize and assure the E2E network slicing SLA from TN domain aspects.

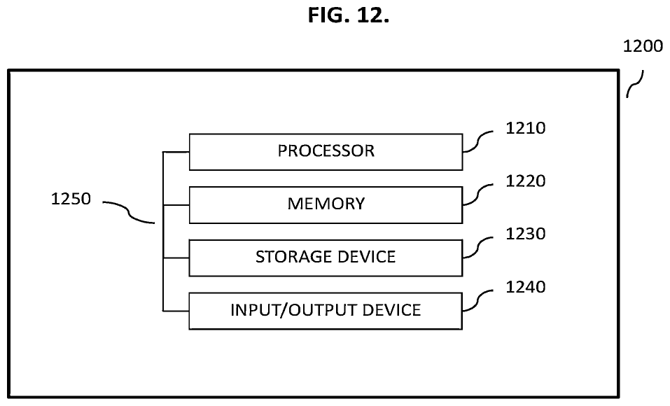

In some implementations, the current subject matter can be configured to be implemented in a system 1200, as shown in FIG. 12. The system 1200 can include one or more of a processor 1210, a memory 1220, a storage device 1230, and an input/output device 1240. Each of the components 1210, 1220, 1230 and 1240 can be interconnected using a system bus 1250. The processor 1210 can be configured to process instructions for execution within the system 600. In some implementations, the processor 1210 can be a single-threaded processor. In alternate implementations, the processor 1210 can be a multi-threaded processor. The processor 1210 can be further configured to process instructions stored in the memory 1220 or on the storage device 1230, including receiving or sending information through the input/output device 1240. The memory 1220 can store information within the system 1200. In some implementations, the memory 1220 can be a computer-readable medium. In alternate implementations, the memory 1220 can be a volatile memory unit. In yet some implementations, the memory 1220 can be a non-volatile memory unit. The storage device 1230 can be capable of providing mass storage for the system 1200. In some implementations, the storage device 1230 can be a computer-readable medium. In alternate implementations, the storage device 1230 can be a floppy disk device, a hard disk device, an optical disk device, a tape device, non-volatile solid state memory, or any other type of storage device. The input/output device 1240 can be configured to provide input/output operations for the system 1200. In some implementations, the input/output device 1240 can include a keyboard and/or pointing device. In alternate implementations, the input/output device 1240 can include a display unit for displaying graphical user interfaces.

An apparatus according to some implementations of the current subject matter can include an NSMF and a TN-NSSMF. The NSMF is configured to request at least a TN domain in a network architecture to create a TN portion of a network slice in a wireless communications system. The TN-NSSMF is configured to manage the TN portion of the network slice. One of the NSMF and the TN-NSSMF has AI/ML integrated therein that is configured to allow the one of the NSMF and the TN-NSSMF to monitor and analyze performance of the network slice in the TN domain.

In some implementations, the current subject matter can include one or more of the following optional features.

In some implementations, the apparatus can further include a REST-API interface between the NSMF and the TN-NSSMF.

In some implementations, the one of the NSMF and the TN-NSSMF that has the AI/ML integrated therein can be the NSMF. Further, the NSMF can be configured to collect input data for the AI/ML, and the input data can include one or more of the following: data mapping between aggregation of radio access network (RAN) and core slices with S-NSSAI and Tx-Slice-ID, data mapping between Tx-Slice-ID and logical DFP paths, telemetry data telemetry data that provides health of a forwarding plane per each DFP, traffic matrices that provide bandwidth consumption of all the slicing flows for each transport link, and SRv6-PM reports. Further, the apparatus can also include a REST-API interface between the NSMF and the TN-NSSMF, and the NSMF can be configured to collect at least some of the input data for the AI/ML via the REST-API interface.

In some implementations, the one of the NSMF and the TN-NSSMF that has the AI/ML integrated therein can be the TN-NSSMF. Further, the TN-NSSMF can includes an NSC, a TN domain manager, or both an NSC and a TN domain manager; the TN-NSSMF can be configured to collect input data for the AI/ML, and the input data can include one or more of the following: data mapping between aggregation of RAN and core slices with S-NSSAI and Tx-Slice-ID, data mapping between Tx-Slice-ID and logical Dedicated Forwarding Planes (DFPs) paths, telemetry data telemetry data that provides health of a forwarding plane per each DFP, traffic matrices that provide bandwidth consumption of all the slicing flows for each transport link, and SRv6-PM reports; and/or the apparatus can also include a REST-API interface between the NSMF and the TN-NSSMF, the TN-NSSMF can include an NSC, and the NSC can be configured to collect slice-mapping and application SLA information from the NSMF via the REST-API interface.

In some implementations, the NSMF can be configured to be communicatively coupled to the TN domain, a RAN domain, and a CN domain. Further, the RAN domain can include at least one base station therein, and the base station can include at least one of an eNodeB and a gNodeB.

In some implementations, the wireless communications system can include at least one of a 5G NR communications system and an LTE communication system.

In some implementations, the AI/ML includes a linear regression model, a Feed Forward Network (FFN)/Convolutional Neural Network (CNN) model, or a Long Short-Term Memory (LSTM) model). Further, the AI/ML can include a model repository including one or more of the linear regression model, the FFN/CNN model, and the LSTM model, and the AI/ML is configured to select a model from the model repository at random or based on initial configuration requirements input by a user. Further, the AI/ML can be configured to use the selected model to perform an evaluation of structured data packets and/or configuration parameters of the wireless communications system to generate a performance score of the network slice. The configuration parameters can include one or more of: TN topology information, TN configuration information, high-level policy information, and subnet information. Further, the AI/ML can be configured to take a corrective action based on the performance score of the network slice, and the corrective action can include creation of a new forwarding plane or assigning additional networks to the network slice.

The systems and methods disclosed herein can be embodied in various forms including, for example, a data processor, such as a computer that also includes a database, digital electronic circuitry, firmware, software, or in combinations of them. Moreover, the above-noted features and other aspects and principles of the present disclosed implementations can be implemented in various environments. Such environments and related applications can be specially constructed for performing the various processes and operations according to the disclosed implementations or they can include a general-purpose computer or computing platform selectively activated or reconfigured by code to provide the necessary functionality. The processes disclosed herein are not inherently related to any particular computer, network, architecture, environment, or other apparatus, and can be implemented by a suitable combination of hardware, software, and/or firmware. For example, various general-purpose machines can be used with programs written in accordance with teachings of the disclosed implementations, or it can be more convenient to construct a specialized apparatus or system to perform the required methods and techniques.

The systems and methods disclosed herein can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

As used herein, the term “user” can refer to any entity including a person or a computer.

Although ordinal numbers such as first, second, and the like can, in some situations, relate to an order; as used in this document ordinal numbers do not necessarily imply an order. For example, ordinal numbers can be merely used to distinguish one item from another. For example, to distinguish a first event from a second event, but need not imply any chronological ordering or a fixed reference system (such that a first event in one paragraph of the description can be different from a first event in another paragraph of the description).

The foregoing description is intended to illustrate but not to limit the scope of the invention, which is defined by the scope of the appended claims. Other implementations are within the scope of the following claims.

These computer programs, which can also be referred to programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, the subject matter described herein can be implemented on a computer having a display device, such as for example a cathode ray tube (CRT) or a liquid crystal display (LCD) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including, but not limited to, acoustic, speech, or tactile input.

The subject matter described herein can be implemented in a computing system that includes a back-end component, such as for example one or more data servers, or that includes a middleware component, such as for example one or more application servers, or that includes a front-end component, such as for example one or more client computers having a graphical user interface or a Web browser through which a user can interact with an implementation of the subject matter described herein, or any combination of such back-end, middleware, or front-end components. The components of the system can be interconnected by any form or medium of digital data communication, such as for example a communication network. Examples of communication networks include, but are not limited to, a local area network (“LAN”), a wide area network (“WAN”), and the Internet.

The computing system can include clients and servers. A client and server are generally, but not exclusively, remote from each other and typically interact through a communication network. The relationship of client and server arises by virtue of computer programs running on the respective computers and having a client-server relationship to each other.

The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub-combinations of the disclosed features and/or combinations and sub-combinations of several further features disclosed above. In addition, the logic flows depicted in the accompanying figures and/or described herein do not necessarily require the particular order shown, or sequential order, to achieve desirable results. Other implementations can be within the scope of the following claims.

1. An apparatus, comprising:
a network slice management function (NSMF) configured to request at least a transport network (TN) domain in a network architecture to create a TN portion of a network slice in a wireless communications system; and
a transport network-network slice subnet management function (TN-NSSMF) configured to manage the TN portion of the network slice;
wherein one of the NSMF and the TN-NSSMF has artificial intelligence/machine learning (AI/ML) integrated therein that is configured to allow the one of the NSMF and the TN-NSSMF to monitor and analyze performance of the network slice in the TN domain.

2. The apparatus of claim 1, further comprising a representational state transfer application programming interface (REST-API) interface between the NSMF and the TN-NSSMF.

3. The apparatus of claim 1, wherein the one of the NSMF and the TN-NSSMF that has the AI/ML integrated therein is the NSMF.

4. The apparatus of claim 3, wherein the NSMF is configured to collect input data from the TN-NSSMF for a workflow of the AI/ML, the input data including one or more of the following:
data mapping between aggregation of radio access network (RAN) and core slices with S-NSSAI and transport slice identifiers (Tx-Slice-ID),
data mapping between Tx-Slice-ID and logical Dedicated Forwarding Planes (DFPs) paths,
telemetry data telemetry data that provides health of a forwarding plane per each DFP,
traffic matrices that provide bandwidth consumption of all the slicing flows for each transport link, and
segment routing over IPv6 (SRv6) performance management (SRv6-PM) reports.

5. The apparatus of claim 4, further comprising a representational state transfer application programming interface (REST-API) interface between the NSMF and the TN-NSSMF; and
the NSMF is configured to collect at least some of the input data for the workflow of the AI/ML via the REST-API interface.

6. The apparatus of claim 4, wherein the workflow of the AI/ML comprises model training and/or inference.

7. The apparatus of claim 1, wherein the one of the NSMF and the TN-NSSMF that has the AI/ML integrated therein is the TN-NSSMF.

8. The apparatus of claim 7, wherein the TN-NSSMF includes a network slice controller (NSC) or a TN domain manager.

9. The apparatus of claim 7, wherein the TN-NSSMF is configured to collect input data for the AI/ML, the input data including one or more of the following:
data mapping between aggregation of radio access network (RAN) and core slices with S-NSSAI and transport slice identifiers (Tx-Slice-ID),
data mapping between Tx-Slice-ID and logical Dedicated Forwarding Planes (DFPs) paths,
telemetry data telemetry data that provides health of a forwarding plane per each DFP,
traffic matrices that provide bandwidth consumption of all the slicing flows for each transport link, and
segment routing over IPv6 (SRv6) performance management (SRv6-PM) reports.

10. The apparatus of claim 7, further comprising a representational state transfer application programming interface (REST-API) interface between the NSMF and the TN-NSSMF, wherein the TN-NSSMF is configured to collect slice-mapping and application service level agreement (SLA) information from the NSMF via the REST-API interface.

11. The apparatus of claim 1, wherein the NSMF is configured to be communicatively coupled to the TN domain, a radio access network (RAN) domain, and a core network (CN) domain.

12. The apparatus of claim 11, wherein the RAN domain includes at least one base station therein, the base station including at least one of an eNodeB and a gNodeB.

13. The apparatus of claim 1, wherein the wireless communications system includes at least one of a 5G New Radio (NR) communications system and a long term evolution (LTE) communication system.

14. The apparatus of claim 1, wherein the AI/ML comprises a linear regression model, a Feed Forward Network (FFN)/Convolutional Neural Network (CNN) model, or a Long Short-Term Memory (LSTM) model).

15. The apparatus of claim 14, wherein the AI/ML comprises a model repository including one or more of the linear regression model, the FFN/CNN model, and the LSTM model.

16. The apparatus of claim 15, wherein the AI/ML is configured to select a model from the model repository at random or based on initial configuration requirements input by a user.

17. The apparatus of claim 16, wherein the AI/ML is configured to use the selected model to perform an evaluation of structured data packets and/or configuration parameters of the wireless communications system to generate a performance score of the network slice.

18. The apparatus of claim 17, wherein the configuration parameters comprises one or more of: TN topology information, TN configuration information, high-level policy information, and subnet information.

19. The apparatus of claim 17, wherein the AI/ML is configured to take a corrective action based on the performance score of the network slice, and wherein the corrective action comprises creation of a new forwarding plane or assigning additional networks to the network slice.

20. An apparatus, comprising:
a network slice management function (NSMF) including:
at least one first processor, and
at least one first non-transitory storage media storing instructions that, when executed by the at least one first processor, request at least a transport network (TN) domain in a network architecture to create a TN portion of a network slice in a wireless communications system; and
a transport network-network slice subnet management function (TN-NSSMF) including:
at least one second processor, and
at least one second non-transitory storage media storing instructions that, when executed by the at least one second processor, manage the TN portion of the network slice;
wherein one of the NSMF and the TN-NSSMF has artificial intelligence/machine learning (AI/ML) integrated therein that is configured to allow the one of the NSMF and the TN-NSSMF to monitor and analyze performance of the network slice in the TN domain.

21-38. (canceled)
